(19) United States
(12) Patent Application Publication
(10) Pub. No.: US 2023/0147146 A1
(43) Pub. Date: May 11, 2023

(54) REFERENCE SIGNAL FOR CROSS-LINK INTERFERENCE MEASUREMENT

(71) Applicant: QUALCOMM INCORPORATED, San Diego, CA (US)

(72) Inventors: Yuwei REN, Beijing (CN); Huilin XU, Temecula, CA (US); Qunfeng HE, San Diego, CA (US)

(21) Appl. No.: 17/915,061

(22) PCT Filed: May 9, 2020
(86) PCT No.: PCT/CN2020/089419

§ 371 Date: Sep. 27, 2022

(51) Int. Cl. H04W 24/10; H04B 17/336; H04W 48/20

(52) U.S. Cl. CPC H04W 24/10; H04B 17/336; H04W 48/20

(57) ABSTRACT

Methods, systems, and devices for wireless communications are described. A first user equipment (UE) may communicate with a base station to measure cross-link interference (CLI) from an aggressor UE. The first UE may receive a CLI measurement configuration which provides a CLI measurement resource for the first UE to use for measurement of CLI from an aggressor UE. The first UE may select, based on a selection priority, a reference cell for estimation of a CLI measurement resource timing. The first may determine a reference cell timing based on a reference signal of the reference cell, and the first UE may estimate the CLI measurement resource timing based on the reference cell timing. The first UE may measure CLI from the aggressor UE in accordance with the CLI measurement resource timing.

### CROSS REFERENCE

The present application is a 371 national stage filing of International PCT Application No. PCT/CN2020/089419 by REN et al. entitled “REFERENCE SIGNAL FOR CROSS-LINK INTERFERENCE MEASUREMENT,” filed May 9, 2020, which is assigned to the assignee hereof, and which is expressly incorporated by reference in its entirety herein.

### FIELD OF TECHNOLOGY

The following relates generally to wireless communications and more specifically to reference signals for cross-link interference (CLI) measurement.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

One or more UEs may be served by separate cells, including separate serving base stations. In some instances, the UEs served by different cells may have different timing, such that one UE may be receiving signals while another UE is transmitting signals. In some cases, UEs may have different timing even when served by the same cell. When the UEs are close together, the UEs may be able to detect signals transmitted by each other. One UE may experience cross-link interference (CLI) caused by the other UE due to conflicting slot configurations.

### SUMMARY

The described techniques relate to improved methods, systems, devices, and apparatuses that support reference signals for cross-link interference (CLI) measurement. Generally, the described techniques provide for CLI measurement by a first user equipment (UE). A first UE may communicate with a base station to measure cross-link interference (CLI) from an aggressor UE. The first UE may receive, from a base station, a CLI measurement configuration which provides a CLI measurement resource for the first UE to use for measurement of CLI from an aggressor UE. The first UE may select, based on a selection priority, a reference cell for estimation of a CLI measurement resource timing. The first UE may determine a reference cell timing based on a reference signal of the reference cell, and the first UE may estimate the CLI measurement resource timing based on the reference cell timing. The first UE may measure CLI from the aggressor UE in accordance with the CLI measurement resource timing.

In some cases, the base station may transmit, to the first UE, and indication of a reference cell to be used by the first UE for estimation of a CLI measurement resource timing, In some cases, the base station may receive, from the first UE, a CLI report from the first UE which may include one or more CLI measurement made by the first UE on the CLI measurement resource in accordance with the CLI measurement resource timing.

A method of wireless communications at a first UE is described. The method may include receiving a CLI measurement configuration which provides a CLI measurement resource for the UE for measurement of CLI from an aggressor UE, selecting, based on a selection priority, a reference cell for estimation of a CLI measurement resource timing, determining a reference cell timing based on a reference signal of the reference cell, estimating the CLI measurement resource timing based on the reference cell timing, and measuring CLI from the aggressor UE in accordance with the CLI measurement resource timing.

An apparatus for wireless communications at a first UE is described. The apparatus may include a processor, memory coupled with the processor, and instructions stored in the memory. The instructions may be executable by the processor to cause the apparatus to receive a CLI measurement configuration which provides a CLI measurement resource for the UE for measurement of CLI from an aggressor UE, select, based on a selection priority, a reference cell for estimation of a CLI measurement resource timing, determine a reference cell timing based on a reference signal of the reference cell, estimate the CLI measurement resource timing based on the reference cell timing, and measure CLI from the aggressor UE in accordance with the CLI measurement resource timing.

Another apparatus for wireless communications at a first UE is described. The apparatus may include means for receiving a CLI measurement configuration which provides a CLI measurement resource for the UE for measurement of CLI from an aggressor UE, selecting, based on a selection priority, a reference cell for estimation of a CLI measurement resource timing, determining a reference cell timing based on a reference signal of the reference cell, estimating the CLI measurement resource timing based on the reference cell timing, and measuring CLI from the aggressor UE in accordance with the CLI measurement resource timing.

A non-transitory computer-readable medium storing code for wireless communications at a first UE is described. The code may include instructions executable by a processor to receive a CLI measurement configuration which provides a CLI measurement resource for the UE for measurement of CLI from an aggressor UE, select, based on a selection priority, a reference cell for estimation of a CLI measurement resource timing, determine a reference cell timing based on a reference signal of the reference cell, estimate the CLI measurement resource timing based on the reference cell timing, and measure CLI from the aggressor UE in accordance with the CLI measurement resource timing.

In some examples of the method, apparatuses, and non-transitory computer-readable medium described herein, selecting the reference cell may include operations, features, means, or instructions for receiving, with the CLI measurement configuration, an indication that the reference cell may be a serving cell of the aggressor UE, and selecting the serving cell of the aggressor UE as the reference cell based on the selection priority.

In some examples of the method, apparatuses, and non-transitory computer-readable medium described herein, the indication includes a SSB index corresponding to the serving cell of the aggressor UE, a CSI-RS index corresponding to the serving cell of the aggressor UE, or both.

In some examples of the method, apparatuses, and non-transitory computer-readable medium described herein, determining the reference cell timing may include operations, features, means, or instructions for using the SSB index or the CSI-RS index as the reference signal from which the reference cell timing may be determined.

Some examples of the method, apparatuses, and non-transitory computer-readable medium described herein may further include operations, features, means, or instructions for identifying a frequency offset of the CLI measurement resource, based on measurements of the reference signal.

Some examples of the method, apparatuses, and non-transitory computer-readable medium described herein may further include operations, features, means, or instructions for applying a frequency correction corresponding to the identified frequency offset in the CLI measurement resource.

In some examples of the method, apparatuses, and non-transitory computer-readable medium described herein, selecting the reference cell may include operations, features, means, or instructions for identifying a reference serving cell configured for estimation of the CLI measurement resource timing, and selecting the reference serving cell as the reference cell based on the selection priority, where the selection priority may be that the UE selects the reference serving cell when the CLI measurement configuration does not identify the reference cell as a serving cell of the aggressor UE.

In some examples of the method, apparatuses, and non-transitory computer-readable medium described herein, determining the reference cell timing may include operations, features, means, or instructions for using a SSB or a CSI-RS of the reference serving cell to determine the reference cell timing.

In some examples of the method, apparatuses, and non-transitory computer-readable medium described herein, selecting the reference cell may include operations, features, means, or instructions for selecting a serving cell of the UE as the reference cell based on the selection priority, where the selection priority may be that the UE selects the serving cell of the UE when the CLI measurement configuration does not identify the reference cell as a serving cell of the aggressor UE, and when no reference serving cell may have been configured.

A method of wireless communications at a base station is described. The method may include transmitting, to a first UE, a CLI measurement configuration which provides a CLI measurement resource for measurement by the first UE of CLI from an aggressor UE, transmitting, to the first UE, an indication of a reference cell to be used by the first UE for estimation of a CLI measurement resource timing, and receiving a CLI report from the first UE which includes one or more CLI measurements made by the first UE on the CLI measurement resource and in accordance with the CLI measurement resource timing.

An apparatus for wireless communications at a base station is described. The apparatus may include a processor, memory coupled with the processor, and instructions stored in the memory. The instructions may be executable by the processor to cause the apparatus to transmit, to a first UE, a CLI measurement configuration which provides a CLI measurement resource for measurement by the first UE of CLI from an aggressor UE, transmit, to the first UE, an indication of a reference cell to be used by the first UE for estimation of a CLI measurement resource timing, and receive a CLI report from the first UE which includes one or more CLI measurements made by the first UE on the CLI measurement resource and in accordance with the CLI measurement resource timing.

Another apparatus for wireless communications at a base station is described. The apparatus may include means for transmitting, to a first UE, a CLI measurement configuration which provides a CLI measurement resource for measurement by the first UE of CLI from an aggressor UE, transmitting, to the first UE, an indication of a reference cell to be used by the first UE for estimation of a CLI measurement resource timing, and receiving a CLI report from the first UE which includes one or more CLI measurements made by the first UE on the CLI measurement resource and in accordance with the CLI measurement resource timing.

A non-transitory computer-readable medium storing code for wireless communications at a base station is described. The code may include instructions executable by a processor to transmit, to a first UE, a CLI measurement configuration which provides a CLI measurement resource for measurement by the first UE of CLI from an aggressor UE, transmit, to the first UE, an indication of a reference cell to be used by the first UE for estimation of a CLI measurement resource timing, and receive a CLI report from the first UE which includes one or more CLI measurements made by the first UE on the CLI measurement resource and in accordance with the CLI measurement resource timing.

In some examples of the method, apparatuses, and non-transitory computer-readable medium described herein, transmitting the indication of the reference cell may include operations, features, means, or instructions for indicating, with the CLI measurement configuration, that the reference cell may be a serving cell of the aggressor UE.

In some examples of the method, apparatuses, and non-transitory computer-readable medium described herein, the indication includes a SSB index corresponding to the serving cell of the aggressor UE, a CSI-RS index corresponding to the serving cell of the aggressor UE, or both.

In some examples of the method, apparatuses, and non-transitory computer-readable medium described herein, transmitting the indication of the reference cell may include operations, features, means, or instructions for indicating, to the first UE, an identifier of a reference serving cell, where the reference serving cell may be different from a serving cell of the aggressor UE.

### BRIEF DESCRIPTION OF THE DRAWINGS

FIG. 1 illustrates an example of a wireless communications system that supports reference signals for cross-link interference (CLI) measurement in accordance with aspects of the present disclosure.

FIG. 2 illustrates an example of a wireless communications system that supports reference signals for CLI measurement in accordance with aspects of the present disclosure.

FIG. 3 illustrates an example of a process flow that supports reference signals for CLI measurement in accordance with aspects of the present disclosure.

FIGS. 4 and 5 show block diagrams of devices that support reference signals for CLI measurement in accordance with aspects of the present disclosure.

FIG. 6 shows a block diagram of a communications manager that supports reference signals for CLI measurement in accordance with aspects of the present disclosure.

FIG. 7 shows a diagram of a system including a device that supports reference signals for CLI measurement in accordance with aspects of the present disclosure.

FIGS. 8 and 9 show block diagrams of devices that support reference signals for CLI measurement in accordance with aspects of the present disclosure.

FIG. 10 shows a block diagram of a communications manager that supports reference signals for CLI measurement in accordance with aspects of the present disclosure.

FIG. 11 shows a diagram of a system including a device that supports reference signals for CLI measurement in accordance with aspects of the present disclosure.

FIGS. 12 through 16 show flowcharts illustrating methods that support reference signals for CLI measurement in accordance with aspects of the present disclosure.

### DETAILED DESCRIPTION

A first user equipment (UE) may be served by a first serving base station in a first serving cell. The serving base station may serve one or more UEs within a coverage area. Another serving cell may be near to or partially overlapping in space with the first serving cell. The second serving cell may include a second serving base station serving one or more UEs in a second coverage area. One of the UEs in the second serving cell may be nearby to one of the UEs in the first serving cell. The UEs may be able to detect transmissions by other UEs.

One of the UEs in the second serving cell may have an uplink/downlink slot format. This uplink/downlink slot format may conflict with the uplink/downlink slot format of the nearby UE in the first serving cell. For example, the second UE may be configured to transmit uplink transmissions in the same slot or slot in which the first UE is configured to receive downlink transmissions. Thus, the uplink transmissions by the second UE may interfere with downlink receptions at the first UE. This may be an example of cross-link interference (CLI), where the second UE is an aggressor UE and the first UE is a victim UE. CLI may occur in cases of time division duplexing (TDD) systems. While described above as occurring between UEs being served by different cells, CLI may also arise between UEs of a same cell, as long as the uplink/downlink slot format of the UEs differ.

The network may configure the first UE with a CLI measurement configuration, so that the victim UE may perform interference management. The victim UE may receive third layer measurement and reporting mechanisms for the CLI measurement. The CLI measurement may include measurements of sounding reference signals (SRSs), or reference signal received power (RSRP) measurement. The measurement resource configuration may also include periodicity, frequency, and resource blocks or orthogonal frequency division multiplexing (OFDM) symbols on which the victim UE is to measure the CLI. The CLI may correspond to a transmission of an uplink reference signal, such as the SRS, or an uplink channel by the aggressor UE. The aggressor UE may use a transmit beam (e.g., a spatial filter for transmission) to transmit the uplink signal, where the transmit beam is the same as the receive beam that the aggressor UE uses to receive downlink signals from the base station.

There may be timing differences between the slot configuration of the victim UE and the slot configuration of the aggressor UE. The victim UE may not need to be aware of the slot configuration of the aggressor UE. In order to measure the CLI, the victim UE may follow the measurement resource configuration received from the network.

However, the measurement resource configuration may not include an indication of a synchronization signal block (SSB) index, channel state information reference signal (CSI-RS) index, or another indication, of the beam for the victim UE to use to perform the CLI measurement. For example, the victim UE may use the same beam that it receive the CLI measurement configuration indication on to perform the CLI measurement. The beam may not be the beam on which the victim UE detects the highest amount of CLI from the aggressor UE.

However, in order to track the CLI measurement resource, CLI measurement may improve if the victim UE receives an indication of an associated SSB index or CSI-RS index of the CLI measurement resource. The UE may also determine an associated SSB or CSI-RS to use for the CLI measurement resource. The SSB or CSI-RS may indicate a particular reference cell to use to determine reference timing and frequency for the CLI measurement resource.

The victim UE may determine which reference cell to use based on a hierarchical selection priority process. The UE may receive and indication of a SSB or CSI-RS corresponding to the serving cell of the aggressor UE. The UE may also receive an indication of a SSB or a CSI-RS corresponding to a reference cell, where the reference cell does not serve the aggressor UE or the victim UE. Or, the UE may determine a reference serving cell to use. If the UE does not receive an indication of the serving cell of the aggressor UE or the reference serving cell, the victim may use a SSB or CSI-RS of its own serving cell to track the CLI measurement resource to perform the CLI measurement.

Thus, the victim UE may estimate a timing and frequency offset of a CLI transmission. The victim UE may determine timing and frequency offset information of the CLI transmission based on information conveyed by or determined from an indicated SSB or CSI-RS. The victim UE may be able to perform CLI measurement resource tracking, and improve CLI measurement.

Aspects of the disclosure are initially described in the context of wireless communications systems. Aspects of the disclosure are then described with respect to a process flow. Aspects of the disclosure are further illustrated by and described with reference to apparatus diagrams, system diagrams, and flowcharts that relate to reference signals for CLI measurement.

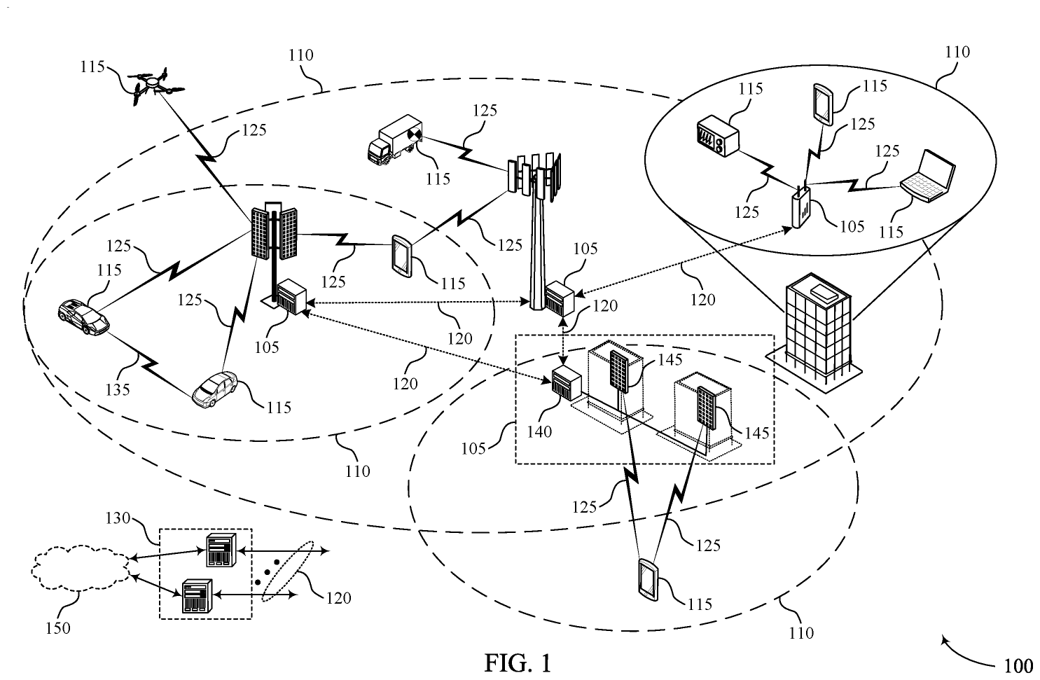

FIG. 1 illustrates an example of a wireless communications system 100 that supports reference signals for CLI measurement in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may communicate with a base station 105 to measure CLI from an aggressor UE 115. The first UE 115 may be served by a base station 105 in a first cell, and the aggressor UE 115 may be served by a different base station 105 in a different cell. The first UE 105 may receive, from the serving base station 105, a CLI measurement configuration which provides a CLI measurement resource for the first UE 115 to use for measurement of CLI from the aggressor UE 115. The first UE 115 may select, based on a selection priority, a reference cell for estimation of a CLI measurement resource timing. The reference cell may correspond to the serving cell of the aggressor UE 115, a separate reference cell, or the reference cell may be the serving cell of the first UE 115. The first UE 115 may determine a reference cell timing based on a reference signal of the reference cell, and the first UE 115 may estimate the CLI measurement resource timing based on the reference cell timing. The first UE 115 may measure CLI from the aggressor UE 115 in accordance with the CLI measurement resource timing.

In some cases, the base station 105 may transmit, to the first UE 115, and indication of a reference cell to be used by the first UE 115 for estimation of a CLI measurement resource timing, In some cases, the base station 105 may receive, from the first UE, a CLI report from the first UE which may include one or more CLI measurement made by the first UE on the CLI measurement resource in accordance with the CLI measurement resource timing.

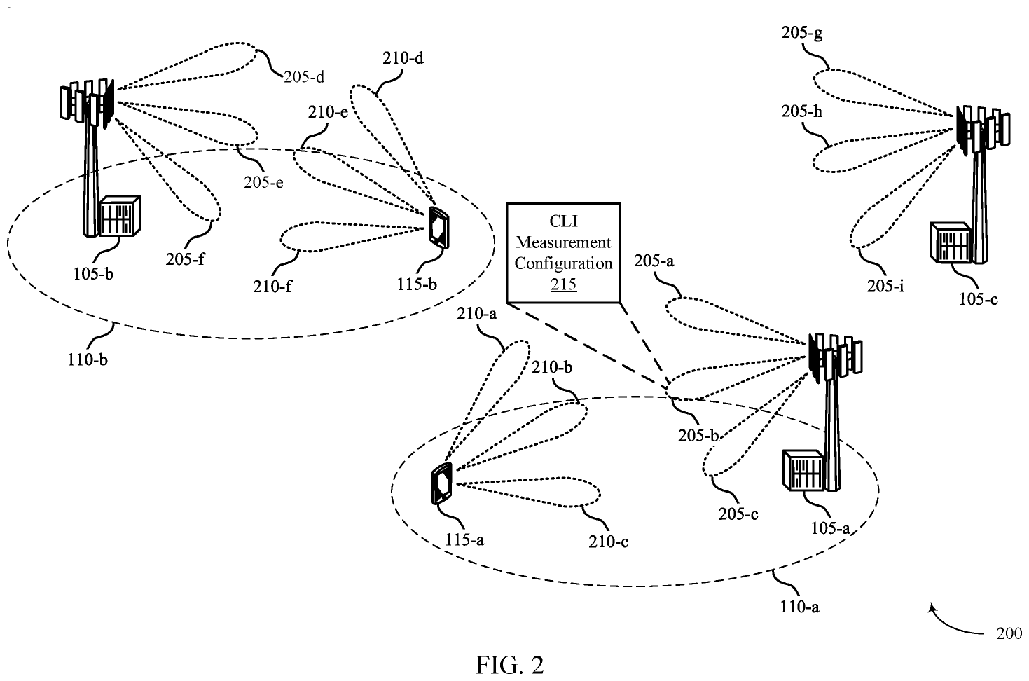

FIG. 2 illustrates an example of a wireless communications system 200 that supports reference signals for CLI measurement in accordance with aspects of the present disclosure. In some examples, wireless communications system 200 may implement aspects of wireless communication system 100. Wireless communications system 200 may include UEs 115-a and 115-b, which may be examples of UEs 115 as described with reference to FIG. 1. Wireless communications system 200 also includes base stations 105-a, 105-b, and 105-c, which may be examples of base stations 105 as described with reference to FIG. 1. UE 115-a may be served by a first cell, which may include serving base station 105-a, where base station 105-a serves coverage area 110-a. UE 115-b may be served by a second cell, which may include serving bae station 105-b, where base station 105-b serves coverage area 110-b. Base station 105-c may also serve another serving cell.

UE 115-a may communicate with base station 105-a by transmitting and receiving signals on beams 210-a, 210-b, and 210-c. Base station 105-a may communicate with UE 115-a using beams 205-a, 205-b, and 205-c.

UE 115-b may communicate with base station 105-b by transmitting and receiving signals on beams 210-d, 210-e, and 210-f. Base station 105-a may communicate with UE 115-a using beams 205-d, 205-e, and 205-f. Another base station 105-c may serve other UEs 115, and base station 105-c may communicate using beams 205-g, 205-h, and 205-i. Each beam may correspond to a spatial filter. The network may provide spatial relation information between SRSs transmitted on a beam and SSB indices and CSI-RS indices. Thus, a SSB index or a CSI-RS index, or both, may correspond to particular beams in a cell.

UE 115-a and UE 115-b may be close in proximity, and may have conflicting slot configurations. For example, UE 115-b may transmit uplink messages during one or more slots in which UE 115-a is configured to receive downlink transmissions from base station 105-a. The uplink transmissions may include SRS, physical uplink control channel (PUCCH) transmissions, physical uplink shared channel (PUSCH) transmission, physical random access channel (PRACH) transmissions, and other uplink transmissions. UE 115-a may therefore experience CLI caused by UE 115-b. UE 115-a may be a victim UE to UE 115-b, which may be an aggressor UE. A PUCCH transmission by UE 115-b, for example, may be based on a spatial relationship between the PUCCH and a SSB or CSI-RS. UE 115-b may transmit the PUCCH (or other uplink signal) with the same spatial filter (e.g., beam 210) as for the reception of the same SSB or CSI-RS.

UE 115-a may use a different receive beam (e.g., beam 210-b) to receive a CSI-RS or SSB configuration information from base station 105-a about a CLI measurement resource for measuring CLI from an uplink transmission by aggressor UE 115-b (e.g., on beam 210-f). Beam 210-b may not have beam correspondence to beam 210-f. Thus, accuracy and efficiency of CLI measurement resource tracking by UE 115-a may be improved by UE 115-a being aware of a particular SSB or CSI-RS associated with the CLI measurement resource.

Base station 105-a may transmit CLI measurement configuration 215 to UE 115-a. CLI measurement configuration may include an indication of a particular CLI measurement resource for UE 115-a to use to measure CLI caused by UE 115-b. Based on CLI measurement configuration 215, UE 115-a may select a reference cell to use for estimation of the CLI measurement resource timing. UE 115-a may select the reference cell based on a selection priority, in order to improve CLI measurement resource tracking and measurement. The selection priority may include a hierarchy of which reference cell may be prioritized to be selected by UE 115-a to use for CLI measurement resource tracking.

The first priority of UE 115-a may be to select the aggressor cell of the aggressor UE 115-b as the reference cell to use for estimation timing. In some cases, CLI measurement configuration 215 may include a serving cell index indicating the aggressor cell (e.g., the cell corresponding to base station 105-b and coverage areas 110-b). If UE 115-a receives this indication, UE 115-a may select the aggressor cell as the reference to determine a reference cell timing. The serving cell index may be a SSB index or a CSI-RS index, or both. In some cases, UE 115-a and UE 115-b are in the same serving cell, and thus the aggressor cell also serves UE 115-a. In this cases, UE 115-a is already aware of the SSB index and CSI-RS index of the serving cell, and may use these to determine the CLI measurement resource timing.

In this case, UE 115-a may use the SSB index or the CSI-RS index as a reference signal. UE 115-a may determine a reference cell timing based on the reference signal. UE 115-a may track the CLI measurement resource based on the reference signal. The CLI transmission timing may be approximated by: T_{CLI}=T_{UL2}+T_{DL2}−T_{DL1} UE 115-a may obtain the system timing of base station 105-a based on downlink timing T_{DL2} of a signal received from base station 105-a, and the configured uplink timing T_{UL2} UE 115-a is configured to use for transmitting uplink signals to base station 105-a. UE 115-a may obtain downlink timing T_{DL1} of the aggressor cell based on the receive SSB or CSI-RS indicated in CLI measurement configuration 215. Thus, UE 115-a may determine transmission timing T_{CLI} of the CLI transmission. UE 115-a may use the transmission timing T_{CLI} to track and measure CLI measurement resource.

In some cases, UE 115-a may also identify a frequency offset of the CLI measurement resource, based on measurements of the reference signal. UE 115-a may obtain the frequency offset of a downlink signal of UE 115-b based on the SSB index or CSI-RS index (or both) indicated in CLI measurement configuration 215. In some cases, aggressor UE 115-b may compensate for this frequency offset in uplink transmissions by UE 115-b. UE 115-a may then apply a frequency correction corresponding to the identified or estimated frequency offset in the CLI measurement resource. UE 115-a may then measure CLI interference from UE 115-b in accordance with the estimated CLI measurement resource timing.

The second priority of UE 115-a may be to select a reference serving cell, where reference serving cell does not serve aggressor UE 115-b or victim UE 115-a. In some cases, CLI measurement configuration 215 may include a serving cell index indicating the reference serving cell (e.g., the serving cell corresponding to base station 105-c). Or, UE 115-a may identify reference serving cell and base station 105-c based on other configuration signaling. The serving cell index may be a SSB index or a CSI-RS index, or both. UE 115-a may select the reference serving cell as the reference cell. UE 115-a may then use the SSB index or the CSI-RS index of the reference serving cell to determine the reference cell timing. UE 115-a may use the reference cell timing to estimate the CLI measurement resource timing, and UE 115-a may measure CLI interference from aggressor UE 115-b in accordance with the CLI measurement resource timing.

The third priority of UE 115-a may be to select the serving cell of UE 115-a as the reference cell. UE 115-a may select the serving cell of UE 115-a if UE 115-a does not receive serving cell index of the aggressor serving cell corresponding to base station 105-b, or receive or determine a serving cell index of the reference serving cell corresponding to base station 105-c. UE 115-a may then use reference cell timing of its own serving cell based on a reference signal of the cell. UE 115-a may estimate the CLI measurement resource timing, and perform the CLI measurement of the CLI caused by UE 115-b.

In some cases, UE 115-a may transmit a CLI report to base station 105-a which includes one or more CLI measurement made by UE 115-a of the CLI resource in accordance with the CLI measurement resource timing.

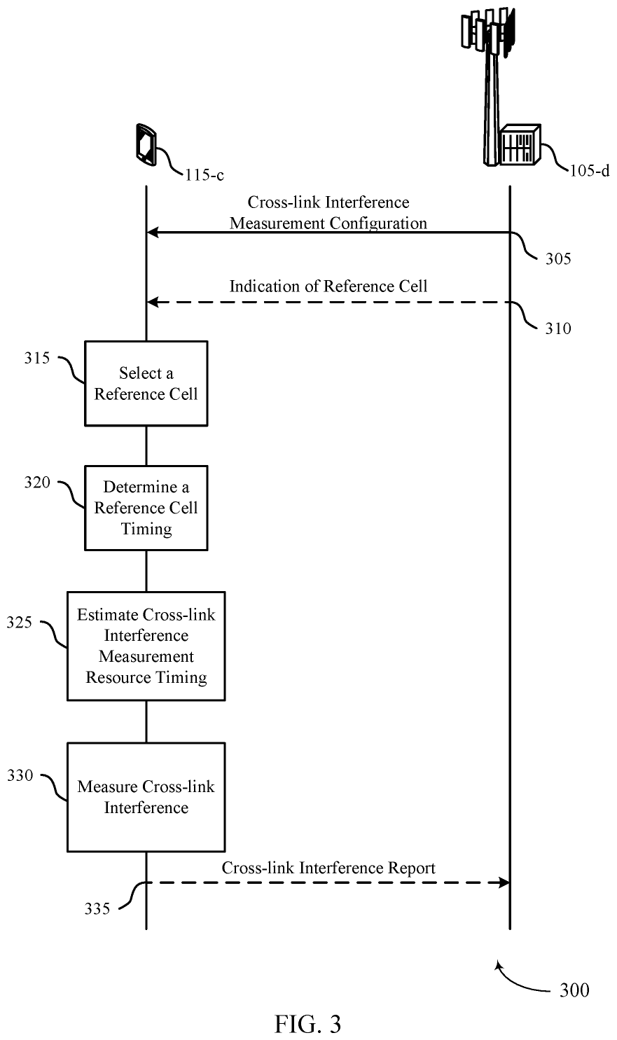

FIG. 3 illustrates an example of a process flow 300 that supports reference signals for CLI measurement in accordance with aspects of the present disclosure. In some examples, process flow 300 may implement aspects of wireless communication systems 100 and 200. Process flow 300 may include UE 115-c, which may be an example of a UE 115 as described with reference to FIG. 1, UE 115-a as described with reference to FIG. 2. Process flow 300 may also include base station 105-d, which may be an example of a base station 105 as described with reference to FIG. 1, and base station 105-a as described with reference to FIG. 2. UE 115-c and base station 105-d may communicate to estimate and measure CLI from an aggressor UE 115.

At 305, UE 115-c may receive, from base station 105-d, a CLI measurement configuration which provides a CLI measurement resource for UE 115-c for measurement of CLI interference from an aggressor UE 115.

In some cases, at 310, UE 115-c may receive, from base station 105-d, and along with the CLI measurement configuration at 305, an indication that the reference cell is a serving cell of the aggressor UE 115. The indication may include a SSB index corresponding to the serving cell of the aggressor UE 115, a CSI-RS corresponding to the serving cell of the aggressor UE 115, or both.

At 315, UE 115-c may select, based on a selection priority, a reference cell for estimation of a CLI measurement resource timing. In cases where UE 115-c receives at 310 and indication that the reference cell is a serving cell of the aggressor UE 115, UE 115-c may select the serving cell of the aggressor UE 115 as the reference cell based on the selection priority.

In some cases, UE 115-c may identify a reference serving cell configured for estimation of the CLI measurement resource timing. In some cases, base station 105-c ay indicate to UE 115-c, and identifier of the reference serving cell, where the reference serving cell is different from a serving cell of the aggressor UE 115. UE 115-c may select the reference serving cell as the reference cell based on the selection priority, where the selection priority is that UE 115-c selects the reference serving cell when the CLI measurement configuration, at 305, does not identify the reference cell as the serving cell of the aggressor UE 115 at.

In other cases, UE 115-c may select a serving cell of UE 115-c as the reference cell based on the selection priority, where the selection priority is that UE 115-c selects the serving cell of UE 115-c when the CLI measurement configuration does not identify the reference cell as a serving cell of the aggressor UE 115, and when no reference serving cell has been configured (e.g., UE 115-c does not identify a reference serving cell).

At 320, UE 115-c may determine a reference cell timing based on a reference signal of the reference cell. In cases where UE 115-c selects, at 315, the reference cell of the aggressor UE 115 as the reference cell, UE 115-c may use the SSB index or the CSI-RS index as the reference signal from which the reference cell timing is determined. In cases where UE 115-c selects the reference serving cell as the reference cell, UE 115-c may use a SSB index or a CSI-RS index of the reference serving cell to determine the reference cell timing.

At 325, UE 115-c may estimate the CLI measurement resource timing based on the reference cell timing. In some cases, UE 115-c may identify a frequency offset of the CLI measurement resource, based on measurement of the reference cell. UE 115-c may apply a frequency correction corresponding to the identified frequency offset in the CLI measurement resource.

At 330, UE 115-c may measure CLI from the aggressor UE 115 in accordance with the CLI measurement resource timing. In some cases, at 335, base station 105-d may receive a CLI report from UE 115-c, which includes one or more CLI measurements may by UE 115-c on the CLI measurement resource and in accordance with the CLI measurement resource timing.

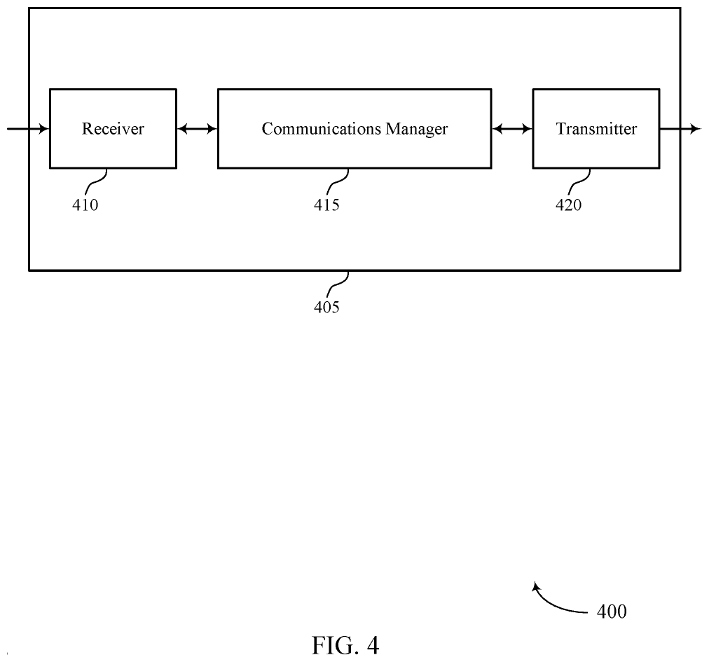

FIG. 4 shows a block diagram 400 of a device 405 that supports reference signals for CLI measurement in accordance with aspects of the present disclosure. The device 405 may be an example of aspects of a UE 115 as described herein. The device 405 may include a receiver 410, a communications manager 415, and a transmitter 420. The device 405 may also include a processor. Each of these components may be in communication with one another (e.g., via one or more buses).

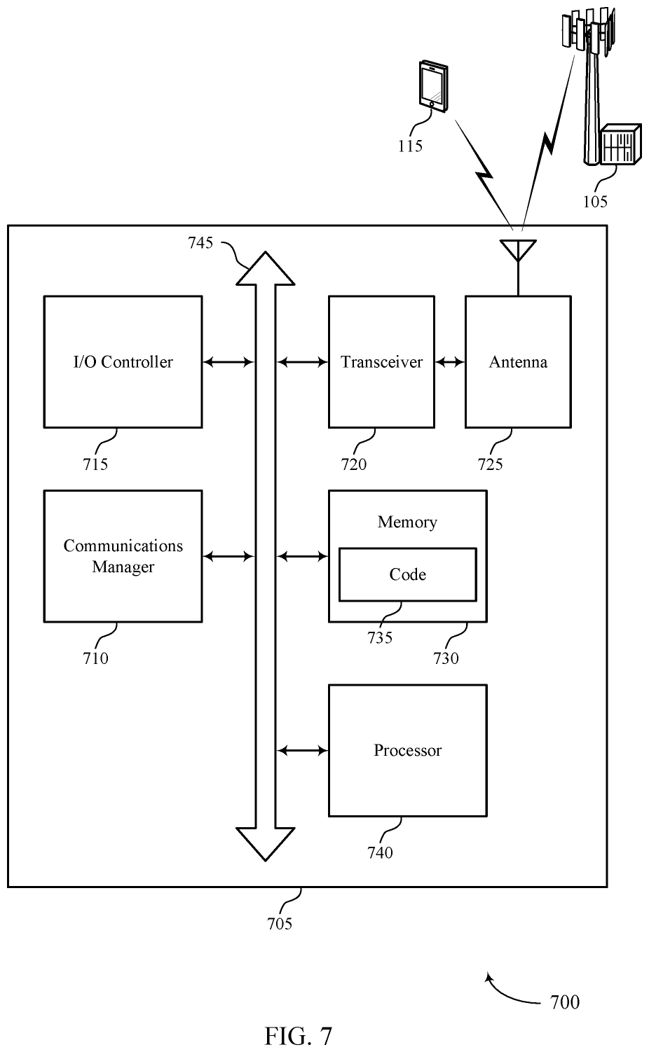

The receiver 410 may receive information such as packets, user data, or control information associated with various information channels (e.g., control channels, data channels, and information related to reference signals for CLI measurement, etc.). Information may be passed on to other components of the device 405. The receiver 410 may be an example of aspects of the transceiver 720 described with reference to FIG. 7. The receiver 410 may utilize a single antenna or a set of antennas.

The communications manager 415 may receive a CLI measurement configuration which provides a CLI measurement resource for the UE for measurement of CLI from an aggressor UE, select, based on a selection priority, a reference cell for estimation of a CLI measurement resource timing, determine a reference cell timing based on a reference signal of the reference cell, estimate the CLI measurement resource timing based on the reference cell timing, and measure CLI from the aggressor UE in accordance with the CLI measurement resource timing. The communications manager 415 may be an example of aspects of the communications manager 710 described herein.

The communications manager 415, or its sub-components, may be implemented in hardware, code (e.g., software or firmware) executed by a processor, or any combination thereof. If implemented in code executed by a processor, the functions of the communications manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 415, or its sub-components, may be physically located at various positions, including being distributed such that portions of functions are implemented at different physical locations by one or more physical components. In some examples, the communications manager 415, or its sub-components, may be a separate and distinct component in accordance with various aspects of the present disclosure. In some examples, the communications manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas.

In some examples, the communications manager 415 described herein may be implemented as a chipset of a wireless modem, and the receiver 410 and the transmitter 420 may be implemented as sets of analog components (e.g., amplifiers, filters, phase shifters, antennas, etc.) The wireless modem may obtain and decode signals from the receiver 410 over a receive interface, and may output signals for transmission to the transmitter 420 over a transmit interface.

The actions performed by the communications manager 415 as describer herein may be implemented to realize one or more potential advantages. One implementation may allow a UE 115 to improve communications efficiency with improve CLI tracking and measurement. Improved CLI tracking may improve accuracy of CLI measurements, therefore improving accuracy of communications adjustments by the network.

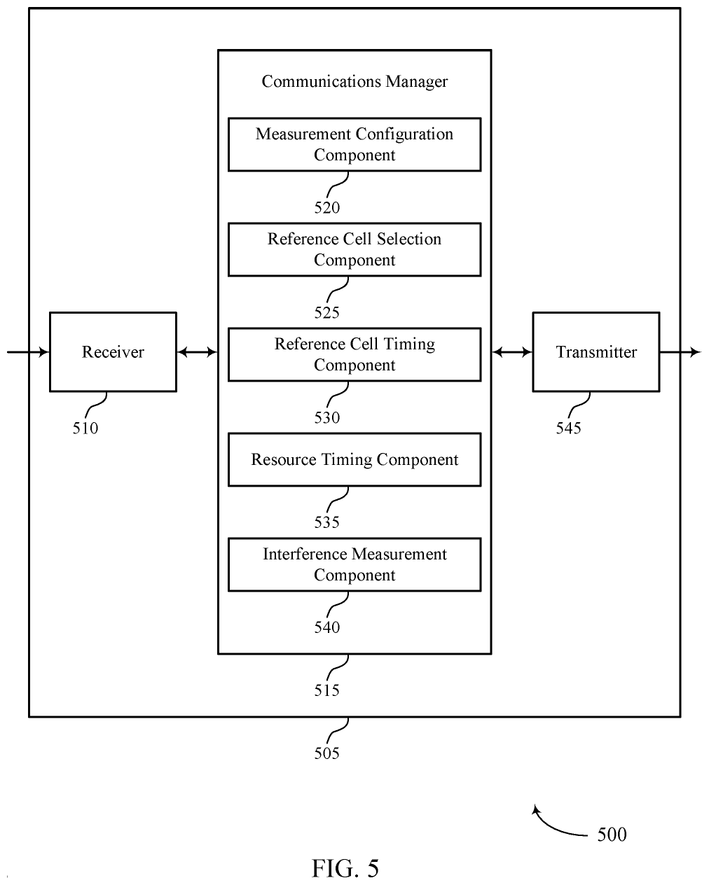

FIG. 5 shows a block diagram 500 of a device 505 that supports reference signals for CLI measurement in accordance with aspects of the present disclosure. The device 505 may be an example of aspects of a device 405, or a UE 115 as described herein. The device 505 may include a receiver 510, a communications manager 515, and a transmitter 545. The device 505 may also include a processor. Each of these components may be in communication with one another (e.g., via one or more buses).

The receiver 510 may receive information such as packets, user data, or control information associated with various information channels (e.g., control channels, data channels, and information related to reference signals for CLI measurement, etc.). Information may be passed on to other components of the device 505. The receiver 510 may be an example of aspects of the transceiver 720 described with reference to FIG. 7. The receiver 510 may utilize a single antenna or a set of antennas.

The communications manager 515 may be an example of aspects of the communications manager 415 as described herein. The communications manager 515 may include a measurement configuration component 520, a reference cell selection component 525, a reference cell timing component 530, a resource timing component 535, and an interference measurement component 540. The communications manager 515 may be an example of aspects of the communications manager 710 described herein.

The measurement configuration component 520 may receive a CLI measurement configuration which provides a CLI measurement resource for the UE for measurement of CLI from an aggressor UE.

The reference cell selection component 525 may select, based on a selection priority, a reference cell for estimation of a CLI measurement resource timing.

The reference cell timing component 530 may determine a reference cell timing based on a reference signal of the reference cell.

The resource timing component 535 may estimate the CLI measurement resource timing based on the reference cell timing.

The interference measurement component 540 may measure CLI from the aggressor UE in accordance with the CLI measurement resource timing.

The transmitter 545 may transmit signals generated by other components of the device 505. In some examples, the transmitter 545 may be collocated with a receiver 510 in a transceiver module. For example, the transmitter 545 may be an example of aspects of the transceiver 720 described with reference to FIG. 7. The transmitter 545 may utilize a single antenna or a set of antennas.

A process of a UE 115 (e.g., controlling the receiver 510, the transmitter 545, or the transceiver 720 as described with reference to FIG. 7) may operate the components described herein to improve communications accuracy at the UE 115. The processor of the UE 115 may operate the receiver 510 to receive an indication of a CLI measurement configuration, which the processor of the UE 115 may use to measure CLI effectively. The processor of the UE 115 may select a reference cell for estimation of CLI resource timing, determine reference cell timing, estimate the CLI measurement resource, and measure the CLI measurement resource, based on the receive CLI measurement configuration. The processor of the UE 115 may therefore improve CLI measurement resource tracking, improving accuracy of CLI measurement. Improved accuracy of CLI measurement may improve overall communications at the UE 115, by providing measurements that may be used by the network to decrease interference at the UE 115.

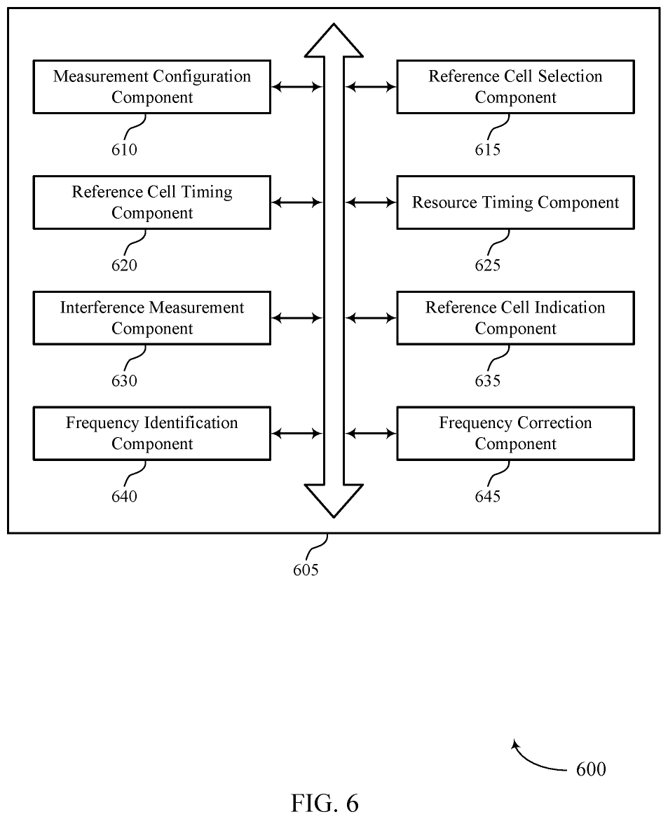

FIG. 6 shows a block diagram 600 of a communications manager 605 that supports reference signals for CLI measurement in accordance with aspects of the present disclosure. The communications manager 605 may be an example of aspects of a communications manager 415, a communications manager 515, or a communications manager 710 described herein. The communications manager 605 may include a measurement configuration component 610, a reference cell selection component 615, a reference cell timing component 620, a resource timing component 625, an interference measurement component 630, a reference cell indication component 635, a frequency identification component 640, and a frequency correction component 645. Each of these modules may communicate, directly or indirectly, with one another (e.g., via one or more buses).

The measurement configuration component 610 may receive a CLI measurement configuration which provides a CLI measurement resource for the UE for measurement of CLI from an aggressor UE.

The reference cell selection component 615 may select, based on a selection priority, a reference cell for estimation of a CLI measurement resource timing. In some examples, the reference cell selection component 615 may select the serving cell of the aggressor UE as the reference cell based on the selection priority. In some examples, the reference cell selection component 615 may identify a reference serving cell configured for estimation of the CLI measurement resource timing.

In some examples, the reference cell selection component 615 may select the reference serving cell as the reference cell based on the selection priority, where the selection priority is that the UE selects the reference serving cell when the CLI measurement configuration does not identify the reference cell as a serving cell of the aggressor UE. In some examples, the reference cell selection component 615 may select a serving cell of the UE as the reference cell based on the selection priority, where the selection priority is that the UE selects the serving cell of the UE when the CLI measurement configuration does not identify the reference cell as a serving cell of the aggressor UE, and when no reference serving cell has been configured.

The reference cell timing component 620 may determine a reference cell timing based on a reference signal of the reference cell. In some examples, the reference cell timing component 620 may use the SSB index or the CSI-RS index as the reference signal from which the reference cell timing is determined. In some examples, the reference cell timing component 620 may use a SSB or a CSI-RS of the reference serving cell to determine the reference cell timing. The resource timing component 625 may estimate the CLI measurement resource timing based on the reference cell timing.

The interference measurement component 630 may measure CLI from the aggressor UE in accordance with the CLI measurement resource timing.

The reference cell indication component 635 may receive, with the CLI measurement configuration, an indication that the reference cell is a serving cell of the aggressor UE.

In some cases, the indication includes a SSB index corresponding to the serving cell of the aggressor UE, a CSI-RS index corresponding to the serving cell of the aggressor UE, or both.

The frequency identification component 640 may identify a frequency offset of the CLI measurement resource, based on measurements of the reference signal.

The frequency correction component 645 may apply a frequency correction corresponding to the identified frequency offset in the CLI measurement resource.

FIG. 7 shows a diagram of a system 700 including a device 705 that supports reference signals for CLI measurement in accordance with aspects of the present disclosure. The device 705 may be an example of or include the components of device 405, device 505, or a UE 115 as described herein. The device 705 may include components for bi-directional voice and data communications including components for transmitting and receiving communications, including a communications manager 710, an I/O controller 715, a transceiver 720, an antenna 725, memory 730, and a processor 740. These components may be in electronic communication via one or more buses (e.g., bus 745).

The communications manager 710 may receive a CLI measurement configuration which provides a CLI measurement resource for the UE for measurement of CLI from an aggressor UE, select, based on a selection priority, a reference cell for estimation of a CLI measurement resource timing, determine a reference cell timing based on a reference signal of the reference cell, estimate the CLI measurement resource timing based on the reference cell timing, and measure CLI from the aggressor UE in accordance with the CLI measurement resource timing.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting reference signals for CLI measurement).

The code 735 may include instructions to implement aspects of the present disclosure, including instructions to support wireless communications. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

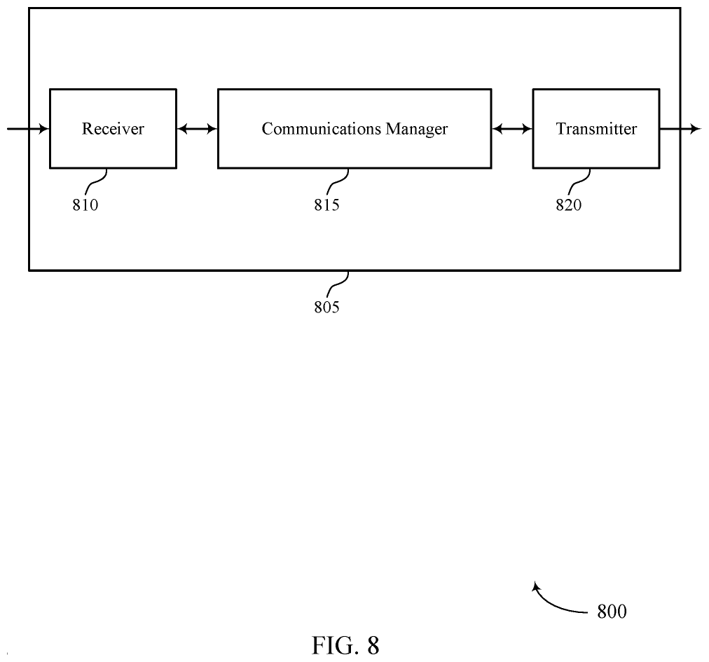

FIG. 8 shows a block diagram 800 of a device 805 that supports reference signals for CLI measurement in accordance with aspects of the present disclosure. The device 805 may be an example of aspects of a base station 105 as described herein. The device 805 may include a receiver 810, a communications manager 815, and a transmitter 820. The device 805 may also include a processor. Each of these components may be in communication with one another (e.g., via one or more buses).

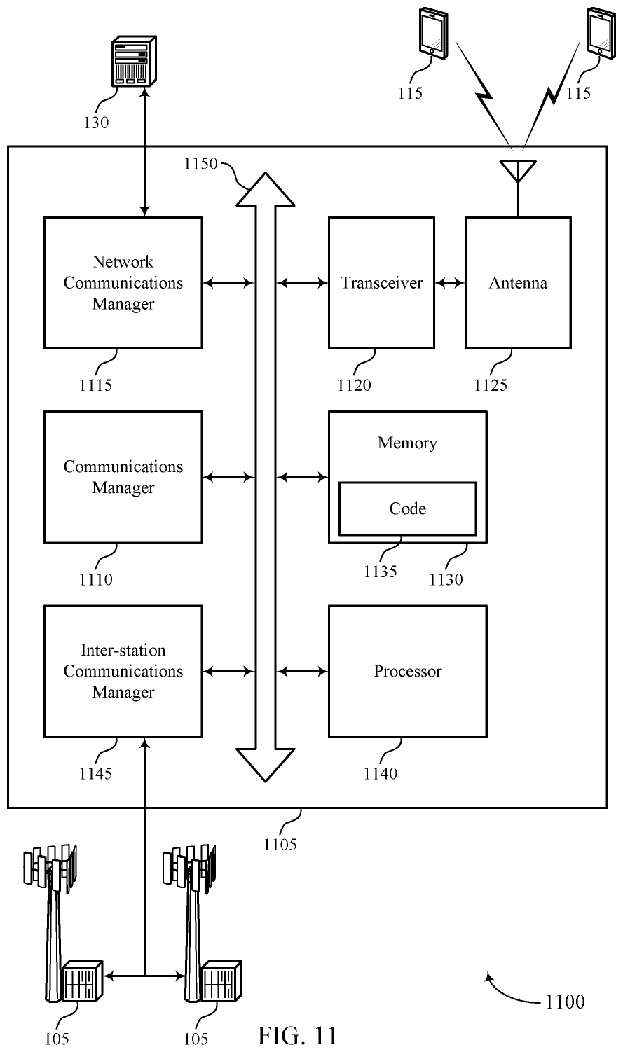

The receiver 810 may receive information such as packets, user data, or control information associated with various information channels (e.g., control channels, data channels, and information related to reference signals for CLI measurement, etc.). Information may be passed on to other components of the device 805. The receiver 810 may be an example of aspects of the transceiver 1120 described with reference to FIG. 11. The receiver 810 may utilize a single antenna or a set of antennas.

The communications manager 815 may transmit, to a first UE, a CLI measurement configuration which provides a CLI measurement resource for measurement by the first UE of CLI from an aggressor UE, transmit, to the first UE, an indication of a reference cell to be used by the first UE for estimation of a CLI measurement resource timing, and receive a CLI report from the first UE which includes one or more CLI measurements made by the first UE on the CLI measurement resource and in accordance with the CLI measurement resource timing. The communications manager 815 may be an example of aspects of the communications manager 1110 described herein.

The communications manager 815, or its sub-components, may be implemented in hardware, code (e.g., software or firmware) executed by a processor, or any combination thereof. If implemented in code executed by a processor, the functions of the communications manager 815, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 820 may transmit signals generated by other components of the device 805. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas.

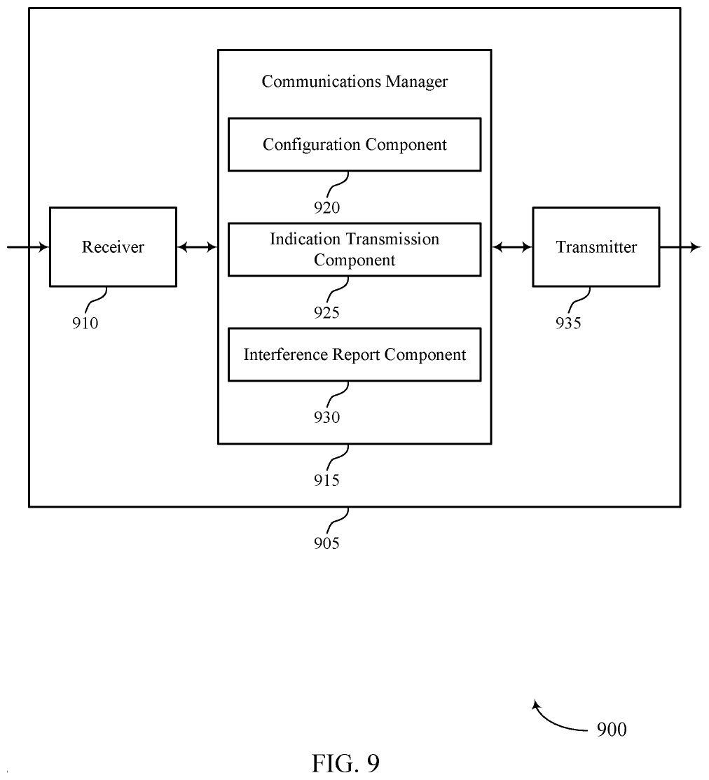

FIG. 9 shows a block diagram 900 of a device 905 that supports reference signals for CLI measurement in accordance with aspects of the present disclosure. The device 905 may be an example of aspects of a device 805, or a base station 105 as described herein. The device 905 may include a receiver 910, a communications manager 915, and a transmitter 935. The device 905 may also include a processor. Each of these components may be in communication with one another (e.g., via one or more buses).

The receiver 910 may receive information such as packets, user data, or control information associated with various information channels (e.g., control channels, data channels, and information related to reference signals for CLI measurement, etc.). Information may be passed on to other components of the device 905. The receiver 910 may be an example of aspects of the transceiver 1120 described with reference to FIG. 11. The receiver 910 may utilize a single antenna or a set of antennas.

The communications manager 915 may be an example of aspects of the communications manager 815 as described herein. The communications manager 915 may include a configuration component 920, an indication transmission component 925, and an interference report component 930. The communications manager 915 may be an example of aspects of the communications manager 1110 described herein.

The configuration component 920 may transmit, to a first UE, a CLI measurement configuration which provides a CLI measurement resource for measurement by the first UE of CLI from an aggressor UE.

The indication transmission component 925 may transmit, to the first UE, an indication of a reference cell to be used by the first UE for estimation of a CLI measurement resource timing.

The interference report component 930 may receive a CLI report from the first UE which includes one or more CLI measurements made by the first UE on the CLI measurement resource and in accordance with the CLI measurement resource timing.

The transmitter 935 may transmit signals generated by other components of the device 905. In some examples, the transmitter 935 may be collocated with a receiver 910 in a transceiver module. For example, the transmitter 935 may be an example of aspects of the transceiver 1120 described with reference to FIG. 11. The transmitter 935 may utilize a single antenna or a set of antennas.

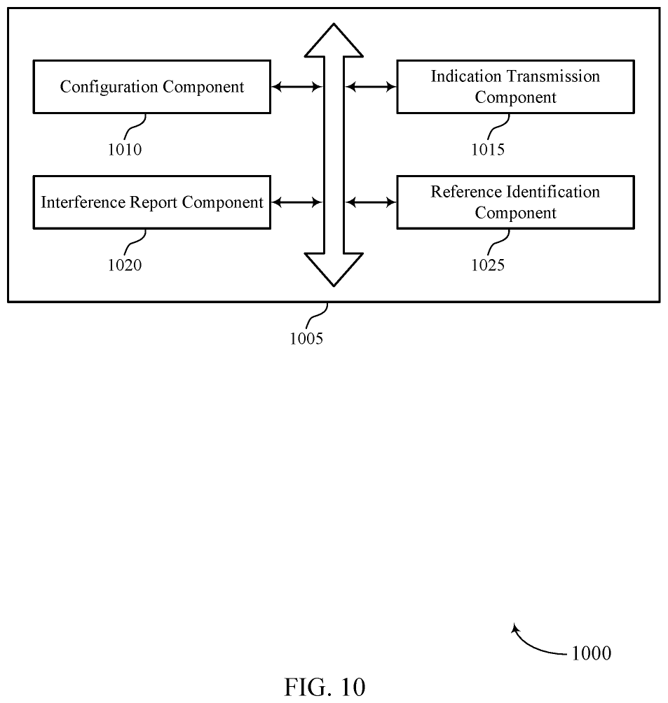

FIG. 10 shows a block diagram 1000 of a communications manager 1005 that supports reference signals for CLI measurement in accordance with aspects of the present disclosure. The communications manager 1005 may be an example of aspects of a communications manager 815, a communications manager 915, or a communications manager 1110 described herein. The communications manager 1005 may include a configuration component 1010, an indication transmission component 1015, an interference report component 1020, and a reference identification component 1025. Each of these modules may communicate, directly or indirectly, with one another (e.g., via one or more buses).

The configuration component 1010 may transmit, to a first UE, a CLI measurement configuration which provides a CLI measurement resource for measurement by the first UE of CLI from an aggressor UE.

The indication transmission component 1015 may transmit, to the first UE, an indication of a reference cell to be used by the first UE for estimation of a CLI measurement resource timing.

In some examples, the indication transmission component 1015 may indicate, with the CLI measurement configuration, that the reference cell is a serving cell of the aggressor UE.

In some cases, the indication includes a SSB index corresponding to the serving cell of the aggressor UE, a CSI-RS index corresponding to the serving cell of the aggressor UE, or both.

The interference report component 1020 may receive a CLI report from the first UE which includes one or more CLI measurements made by the first UE on the CLI measurement resource and in accordance with the CLI measurement resource timing.

The reference identification component 1025 may indicate, to the first UE, an identifier of a reference serving cell, where the reference serving cell is different from a serving cell of the aggressor UE.

FIG. 11 shows a diagram of a system 1100 including a device 1105 that supports reference signals for CLI measurement in accordance with aspects of the present disclosure. The device 1105 may be an example of or include the components of device 805, device 905, or a base station 105 as described herein. The device 1105 may include components for bi-directional voice and data communications including components for transmitting and receiving communications, including a communications manager 1110, a network communications manager 1115, a transceiver 1120, an antenna 1125, memory 1130, a processor 1140, and an inter-station communications manager 1145. These components may be in electronic communication via one or more buses (e.g., bus 1150).

The communications manager 1110 may transmit, to a first UE, a CLI measurement configuration which provides a CLI measurement resource for measurement by the first UE of CLI from an aggressor UE, transmit, to the first UE, an indication of a reference cell to be used by the first UE for estimation of a CLI measurement resource timing, and receive a CLI report from the first UE which includes one or more CLI measurements made by the first UE on the CLI measurement resource and in accordance with the CLI measurement resource timing.

The network communications manager 1115 may manage communications with the core network (e.g., via one or more wired backhaul links). For example, the network communications manager 1115 may manage the transfer of data communications for client devices, such as one or more UEs 115.

The transceiver 1120 may communicate bi-directionally, via one or more antennas, wired, or wireless links as described above. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include RAM, ROM, or a combination thereof. The memory 1130 may store computer-readable code 1135 including instructions that, when executed by a processor (e.g., the processor 1140) cause the device to perform various functions described herein. In some cases, the memory 1130 may contain, among other things, a BIOS which may control basic hardware or software operation such as the interaction with peripheral components or devices.

The processor 1140 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some cases, a memory controller may be integrated into processor 1140. The processor 1140 may be configured to execute computer-readable instructions stored in a memory (e.g., the memory 1130) to cause the device 1105 to perform various functions (e.g., functions or tasks supporting reference signals for CLI measurement).

The inter-station communications manager 1145 may manage communications with other base station 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communication network technology to provide communication between base stations 105.

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

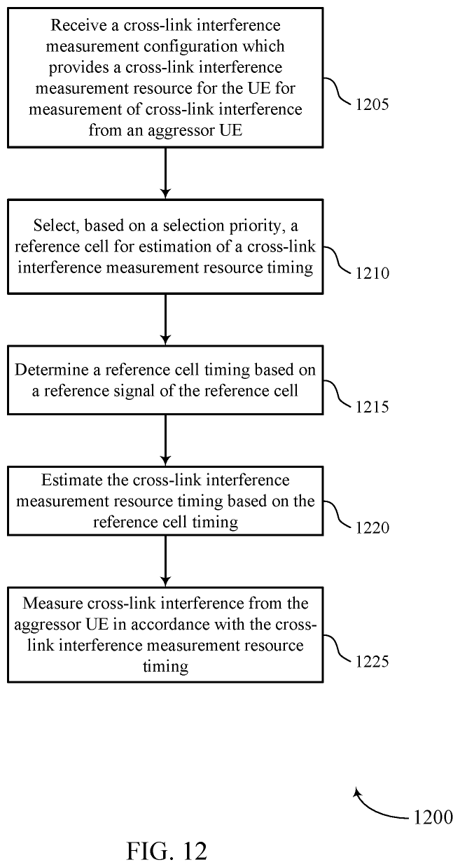

FIG. 12 shows a flowchart illustrating a method 1200 that supports reference signals for CLI measurement in accordance with aspects of the present disclosure. The operations of method 1200 may be implemented by a UE 115 or its components as described herein. For example, the operations of method 1200 may be performed by a communications manager as described with reference to FIGS. 4 through 7. In some examples, a UE may execute a set of instructions to control the functional elements of the UE to perform the functions described below. Additionally or alternatively, a UE may perform aspects of the functions described below using special-purpose hardware.

At 1205, the UE may receive a CLI measurement configuration which provides a CLI measurement resource for the UE for measurement of CLI from an aggressor UE. The operations of 1205 may be performed according to the methods described herein. In some examples, aspects of the operations of 1205 may be performed by a measurement configuration component as described with reference to FIGS. 4 through 7.

At 1210, the UE may select, based on a selection priority, a reference cell for estimation of a CLI measurement resource timing. The operations of 1210 may be performed according to the methods described herein. In some examples, aspects of the operations of 1210 may be performed by a reference cell selection component as described with reference to FIGS. 4 through 7.

At 1215, the UE may determine a reference cell timing based on a reference signal of the reference cell. The operations of 1215 may be performed according to the methods described herein. In some examples, aspects of the operations of 1215 may be performed by a reference cell timing component as described with reference to FIGS. 4 through 7.

At 1220, the UE may estimate the CLI measurement resource timing based on the reference cell timing. The operations of 1220 may be performed according to the methods described herein. In some examples, aspects of the operations of 1220 may be performed by a resource timing component as described with reference to FIGS. 4 through 7.

At 1225, the UE may measure CLI from the aggressor UE in accordance with the CLI measurement resource timing. The operations of 1225 may be performed according to the methods described herein. In some examples, aspects of the operations of 1225 may be performed by an interference measurement component as described with reference to FIGS. 4 through 7.

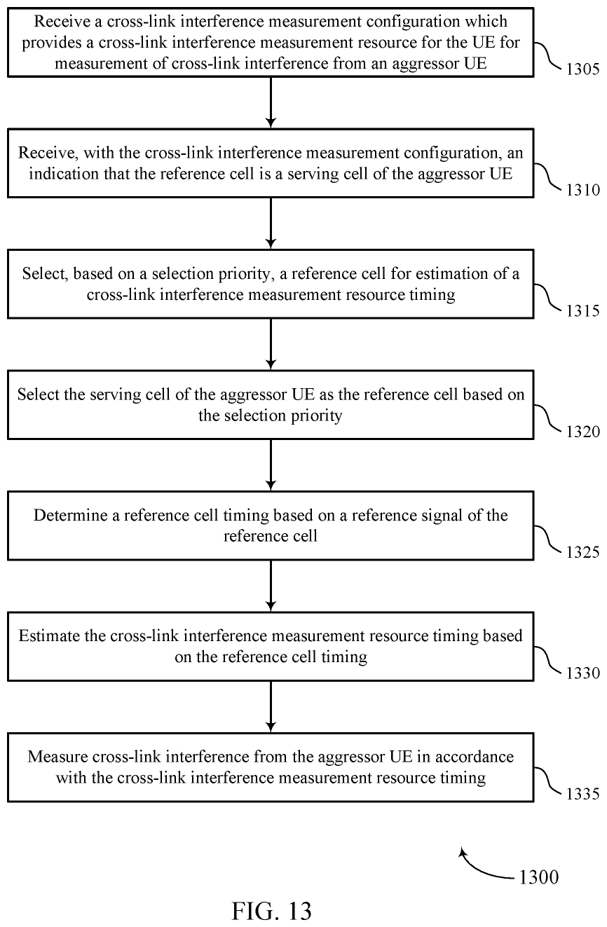

FIG. 13 shows a flowchart illustrating a method 1300 that supports reference signals for CLI measurement in accordance with aspects of the present disclosure. The operations of method 1300 may be implemented by a UE 115 or its components as described herein. For example, the operations of method 1300 may be performed by a communications manager as described with reference to FIGS. 4 through 7. In some examples, a UE may execute a set of instructions to control the functional elements of the UE to perform the functions described below. Additionally or alternatively, a UE may perform aspects of the functions described below using special-purpose hardware.

At 1305, the UE may receive a CLI measurement configuration which provides a CLI measurement resource for the UE for measurement of CLI from an aggressor UE. The operations of 1305 may be performed according to the methods described herein. In some examples, aspects of the operations of 1305 may be performed by a measurement configuration component as described with reference to FIGS. 4 through 7.

At 1310, the UE may receive, with the CLI measurement configuration, an indication that the reference cell is a serving cell of the aggressor UE. The operations of 1310 may be performed according to the methods described herein. In some examples, aspects of the operations of 1310 may be performed by a reference cell indication component as described with reference to FIGS. 4 through 7.

At 1315, the UE may select, based on a selection priority, a reference cell for estimation of a CLI measurement resource timing. The operations of 1315 may be performed according to the methods described herein. In some examples, aspects of the operations of 1315 may be performed by a reference cell selection component as described with reference to FIGS. 4 through 7.

At 1320, the UE may select the serving cell of the aggressor UE as the reference cell based on the selection priority. The operations of 1320 may be performed according to the methods described herein. In some examples, aspects of the operations of 1320 may be performed by a reference cell selection component as described with reference to FIGS. 4 through 7.

At 1325, the UE may determine a reference cell timing based on a reference signal of the reference cell. The operations of 1325 may be performed according to the methods described herein. In some examples, aspects of the operations of 1325 may be performed by a reference cell timing component as described with reference to FIGS. 4 through 7.

At 1330, the UE may estimate the CLI measurement resource timing based on the reference cell timing. The operations of 1330 may be performed according to the methods described herein. In some examples, aspects of the operations of 1330 may be performed by a resource timing component as described with reference to FIGS. 4 through 7.

At 1335, the UE may measure CLI from the aggressor UE in accordance with the CLI measurement resource timing. The operations of 1335 may be performed according to the methods described herein. In some examples, aspects of the operations of 1335 may be performed by an interference measurement component as described with reference to FIGS. 4 through 7.

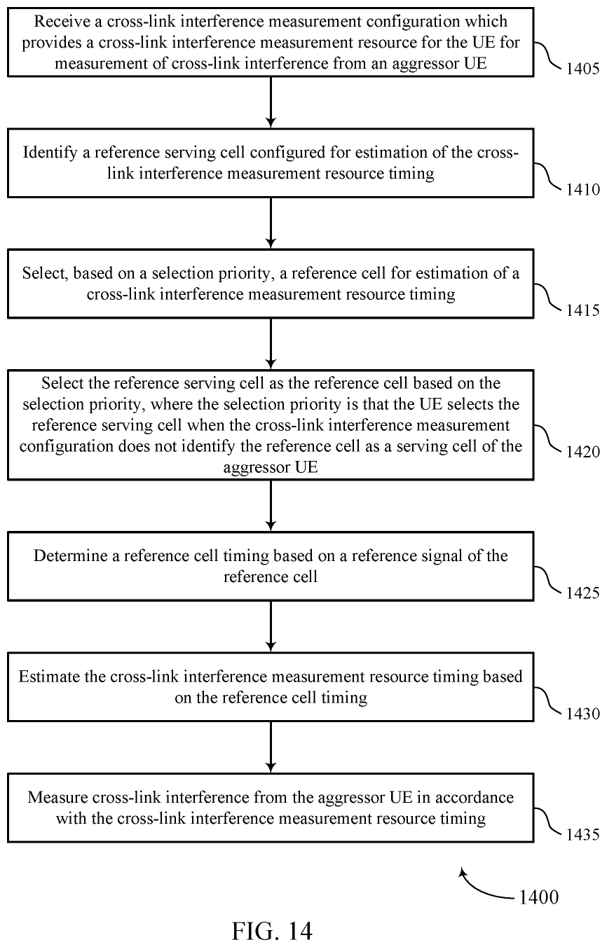

FIG. 14 shows a flowchart illustrating a method 1400 that supports reference signals for CLI measurement in accordance with aspects of the present disclosure. The operations of method 1400 may be implemented by a UE 115 or its components as described herein. For example, the operations of method 1400 may be performed by a communications manager as described with reference to FIGS. 4 through 7. In some examples, a UE may execute a set of instructions to control the functional elements of the UE to perform the functions described below. Additionally or alternatively, a UE may perform aspects of the functions described below using special-purpose hardware.

At 1405, the UE may receive a CLI measurement configuration which provides a CLI measurement resource for the UE for measurement of CLI from an aggressor UE. The operations of 1405 may be performed according to the methods described herein. In some examples, aspects of the operations of 1405 may be performed by a measurement configuration component as described with reference to FIGS. 4 through 7.

At 1410, the UE may identify a reference serving cell configured for estimation of the CLI measurement resource timing. The operations of 1410 may be performed according to the methods described herein. In some examples, aspects of the operations of 1410 may be performed by a reference cell selection component as described with reference to FIGS. 4 through 7.

At 1415, the UE may select, based on a selection priority, a reference cell for estimation of a CLI measurement resource timing. The operations of 1415 may be performed according to the methods described herein. In some examples, aspects of the operations of 1415 may be performed by a reference cell selection component as described with reference to FIGS. 4 through 7.

At 1420, the UE may select the reference serving cell as the reference cell based on the selection priority, where the selection priority is that the UE selects the reference serving cell when the CLI measurement configuration does not identify the reference cell as a serving cell of the aggressor UE. The operations of 1420 may be performed according to the methods described herein. In some examples, aspects of the operations of 1420 may be performed by a reference cell selection component as described with reference to FIGS. 4 through 7.

At 1425, the UE may determine a reference cell timing based on a reference signal of the reference cell. The operations of 1425 may be performed according to the methods described herein. In some examples, aspects of the operations of 1425 may be performed by a reference cell timing component as described with reference to FIGS. 4 through 7.

At 1430, the UE may estimate the CLI measurement resource timing based on the reference cell timing. The operations of 1430 may be performed according to the methods described herein. In some examples, aspects of the operations of 1430 may be performed by a resource timing component as described with reference to FIGS. 4 through 7.

At 1435, the UE may measure CLI from the aggressor UE in accordance with the CLI measurement resource timing. The operations of 1435 may be performed according to the methods described herein. In some examples, aspects of the operations of 1435 may be performed by an interference measurement component as described with reference to FIGS. 4 through 7.

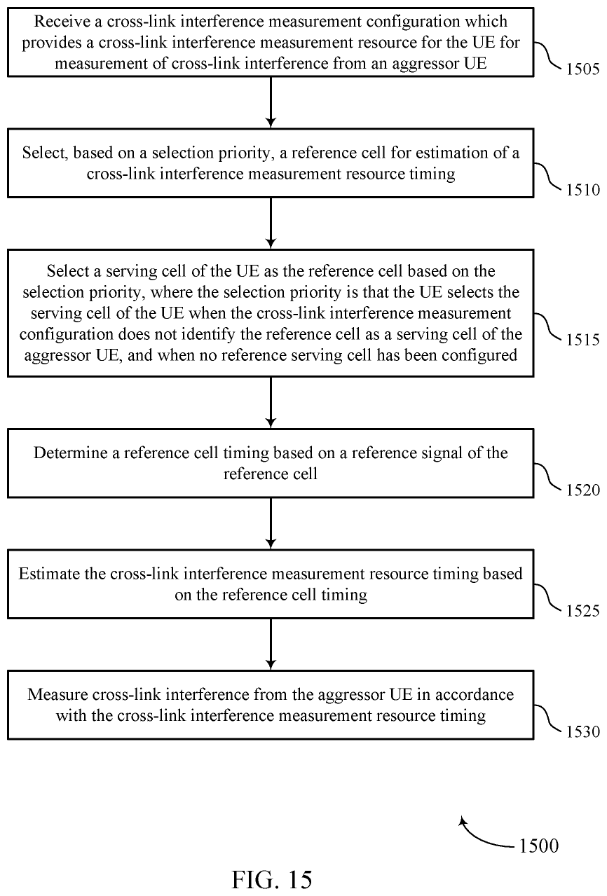

FIG. 15 shows a flowchart illustrating a method 1500 that supports reference signals for CLI measurement in accordance with aspects of the present disclosure. The operations of method 1500 may be implemented by a UE 115 or its components as described herein. For example, the operations of method 1500 may be performed by a communications manager as described with reference to FIGS. 4 through 7. In some examples, a UE may execute a set of instructions to control the functional elements of the UE to perform the functions described below. Additionally or alternatively, a UE may perform aspects of the functions described below using special-purpose hardware.

At 1505, the UE may receive a CLI measurement configuration which provides a CLI measurement resource for the UE for measurement of CLI from an aggressor UE. The operations of 1505 may be performed according to the methods described herein. In some examples, aspects of the operations of 1505 may be performed by a measurement configuration component as described with reference to FIGS. 4 through 7.

At 1510, the UE may select, based on a selection priority, a reference cell for estimation of a CLI measurement resource timing. The operations of 1510 may be performed according to the methods described herein. In some examples, aspects of the operations of 1510 may be performed by a reference cell selection component as described with reference to FIGS. 4 through 7.

At 1515, the UE may select a serving cell of the UE as the reference cell based on the selection priority, where the selection priority is that the UE selects the serving cell of the UE when the CLI measurement configuration does not identify the reference cell as a serving cell of the aggressor UE, and when no reference serving cell has been configured. The operations of 1515 may be performed according to the methods described herein. In some examples, aspects of the operations of 1515 may be performed by a reference cell selection component as described with reference to FIGS. 4 through 7.

At 1520, the UE may determine a reference cell timing based on a reference signal of the reference cell. The operations of 1520 may be performed according to the methods described herein. In some examples, aspects of the operations of 1520 may be performed by a reference cell timing component as described with reference to FIGS. 4 through 7.

At 1525, the UE may estimate the CLI measurement resource timing based on the reference cell timing. The operations of 1525 may be performed according to the methods described herein. In some examples, aspects of the operations of 1525 may be performed by a resource timing component as described with reference to FIGS. 4 through 7.

At 1530, the UE may measure CLI from the aggressor UE in accordance with the CLI measurement resource timing. The operations of 1530 may be performed according to the methods described herein. In some examples, aspects of the operations of 1530 may be performed by an interference measurement component as described with reference to FIGS. 4 through 7.

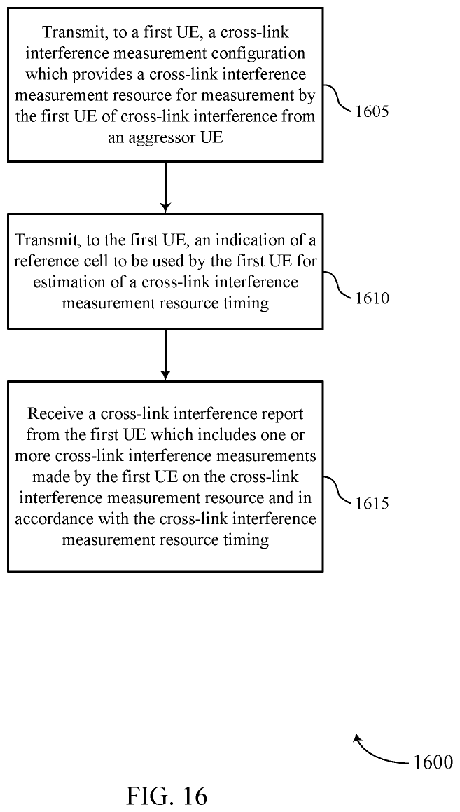

FIG. 16 shows a flowchart illustrating a method 1600 that supports reference signals for CLI measurement in accordance with aspects of the present disclosure. The operations of method 1600 may be implemented by a base station 105 or its components as described herein. For example, the operations of method 1600 may be performed by a communications manager as described with reference to FIGS. 8 through 11. In some examples, a base station may execute a set of instructions to control the functional elements of the base station to perform the functions described below. Additionally or alternatively, a base station may perform aspects of the functions described below using special-purpose hardware.

At 1605, the base station may transmit, to a first UE, a CLI measurement configuration which provides a CLI measurement resource for measurement by the first UE of CLI from an aggressor UE. The operations of 1605 may be performed according to the methods described herein. In some examples, aspects of the operations of 1605 may be performed by a configuration component as described with reference to FIGS. 8 through 11.

At 1610, the base station may transmit, to the first UE, an indication of a reference cell to be used by the first UE for estimation of a CLI measurement resource timing. The operations of 1610 may be performed according to the methods described herein. In some examples, aspects of the operations of 1610 may be performed by an indication transmission component as described with reference to FIGS. 8 through 11.

At 1615, the base station may receive a CLI report from the first UE which includes one or more CLI measurements made by the first UE on the CLI measurement resource and in accordance with the CLI measurement resource timing. The operations of 1615 may be performed according to the methods described herein. In some examples, aspects of the operations of 1615 may be performed by an interference report component as described with reference to FIGS. 8 through 11.

It should be noted that the methods described herein describe possible implementations, and that the operations and the steps may be rearranged or otherwise modified and that other implementations are possible. Further, aspects from two or more of the methods may be combined.

Example 1: A method of wireless communication, comprising: receiving a CLI measurement configuration which provides a CLI measurement resource for the UE for measurement of CLI from an aggressor UE; selecting, based on a selection priority, a reference cell for estimation of a CLI measurement resource timing; determining a reference cell timing based on a reference signal of the reference cell; estimating the CLI measurement resource timing based on the reference cell timing; and measuring CLI from the aggressor UE in accordance with the CLI measurement resource timing.

Example 2: The method of example 1, further comprising: receiving, with the CLI measurement configuration, an indication that the reference cell may be a serving cell of the aggressor UE; and selecting the serving cell of the aggressor UE as the reference cell based on the selection priority.

Example 3: The method of any of examples 1 or 2, wherein the indication includes a SSB index corresponding to the serving cell of the aggressor UE, a CSI-RS index corresponding to the serving cell of the aggressor UE, or both.

Example 4: The method of any of examples 1-3, further comprising: using the SSB index or the CSI-RS index as the reference signal from which the reference cell timing may be determined.

Example 5: The method of any of examples 1-4, further comprising: identifying a frequency offset of the CLI measurement resource, based at least in part on measurements of the reference signal.

Example 6: The method of any of examples 1-5, further comprising: applying a frequency correction corresponding to the identified frequency offset in the CLI measurement resource.

Example 7: The method of any of examples 1 and 5-6, further comprising: identifying a reference serving cell configured for estimation of the CLI measurement resource timing; and selecting the reference serving cell as the reference cell based on the selection priority, where the selection priority may be that the UE selects the reference serving cell when the CLI measurement configuration does not identify the reference cell as a serving cell of the aggressor UE.

Example 8: The method of any of examples 1 and 5-7, further comprising: using a SSB or a CSI-RS of the reference serving cell to determine the reference cell timing.

Example 9: The method of any of examples 1 and 5-6, further comprising: selecting a serving cell of the UE as the reference cell based on the selection priority, where the selection priority may be that the UE selects the serving cell of the UE when the CLI measurement configuration does not identify the reference cell as a serving cell of the aggressor UE, and when no reference serving cell may have been configured.

Example 10: An apparatus comprising at least one means for performing a method of any of examples 1-9.

Example 11: An apparatus for wireless communications comprising a processor; memory coupled with the processor; and instructions stored in the memory and executable by the processor to cause the apparatus to perform a method of any of examples 1-9.

Example 12: A non-transitory computer-readable medium storing code for wireless communications, the code comprising instructions executable by a processor to perform a method od any of examples 1-9.

Example 13: A method of wireless communication, comprising: transmitting, to a first UE, a CLI measurement configuration which provides a CLI measurement resource for measurement by the first UE of CLI from an aggressor UE; transmitting, to the first UE, an indication of a reference cell to be used by the first UE for estimation of a CLI measurement resource timing; and receiving a CLI report from the first UE which includes one or more CLI measurements made by the first UE on the CLI measurement resource and in accordance with the CLI measurement resource timing.

Example 14: The method of example 13, further comprising: indicating, with the CLI measurement configuration, that the reference cell is a serving cell of the aggressor UE.

Example 15: The method of any of examples 13 and 14, wherein: the indication comprises a SSB index corresponding to the serving cell of the aggressor UE, a CSI-RS index corresponding to the serving cell of the aggressor UE, or both.

Example 16: The method of any of examples 13-15, further comprising: indicating, to the first UE, an identifier of a reference serving cell, wherein the reference serving cell is different from a serving cell of the aggressor UE.

Example 17: An apparatus comprising at least one means for performing a method of any of examples 13-15.

Example 18: An apparatus for wireless communications comprising a processor; memory coupled with the processor; and instructions stored in the memory and executable by the processor to cause the apparatus to perform a method of any of examples 13-15.

Example 19: A non-transitory computer-readable medium storing code for wireless communications, the code comprising instructions executable by a processor to perform a method of any of examples 13-15.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a first user equipment (UE), comprising:
receiving a cross-link interference measurement configuration which provides a cross-link interference measurement resource for the UE for measurement of cross-link interference from an aggressor UE;
selecting, based at least in part on a selection priority, a reference cell for estimation of a cross-link interference measurement resource timing;
determining a reference cell timing based on a reference signal of the reference cell;
estimating the cross-link interference measurement resource timing based at least in part on the reference cell timing; and
measuring cross-link interference from the aggressor UE in accordance with the cross-link interference measurement resource timing.

2. The method of claim 1, wherein selecting the reference cell comprises:
receiving, with the cross-link interference measurement configuration, an indication that the reference cell is a serving cell of the aggressor UE; and
selecting the serving cell of the aggressor UE as the reference cell based at least in part on the selection priority.

3. The method of claim 2, wherein the indication comprises a synchronization signal block index corresponding to the serving cell of the aggressor UE, a channel state information reference signal index corresponding to the serving cell of the aggressor UE, or both.

4. The method of claim 3, wherein determining the reference cell timing comprises:
using the synchronization signal block index or the channel state information reference signal index as the reference signal from which the reference cell timing is determined.

5. The method of claim 1, further comprising:
identifying a frequency offset of the cross-link interference measurement resource, based at least in part on measurements of the reference signal.

6. The method of claim 5, further comprising:
applying a frequency correction corresponding to the identified frequency offset in the cross-link interference measurement resource.

7. The method of claim 1, wherein selecting the reference cell comprises:
identifying a reference serving cell configured for estimation of the cross-link interference measurement resource timing; and
selecting the reference serving cell as the reference cell based at least in part on the selection priority, wherein the selection priority is that the UE selects the reference serving cell when the cross-link interference measurement configuration does not identify the reference cell as a serving cell of the aggressor UE.

8. The method of claim 7, wherein determining the reference cell timing comprises:
using a synchronization signal block or a channel state information reference signal of the reference serving cell to determine the reference cell timing.

9. The method of claim 1, wherein selecting the reference cell comprises:
selecting a serving cell of the UE as the reference cell based at least in part on the selection priority, wherein the selection priority is that the UE selects the serving cell of the UE when the cross-link interference measurement configuration does not identify the reference cell as a serving cell of the aggressor UE, and when no reference serving cell has been configured.

10. A method for wireless communications at a base station, comprising:
transmitting, to a first user equipment (UE), a cross-link interference measurement configuration which provides a cross-link interference measurement resource for measurement by the first UE of cross-link interference from an aggressor UE;
transmitting, to the first UE, an indication of a reference cell to be used by the first UE for estimation of a cross-link interference measurement resource timing; and
receiving a cross-link interference report from the first UE which includes one or more cross-link interference measurements made by the first UE on the cross-link interference measurement resource and in accordance with the cross-link interference measurement resource timing.

11. The method of claim 10, wherein transmitting the indication of the reference cell comprises:
indicating, with the cross-link interference measurement configuration, that the reference cell is a serving cell of the aggressor UE.

12. The method of claim 11, wherein the indication comprises a synchronization signal block index corresponding to the serving cell of the aggressor UE, a channel state information reference signal index corresponding to the serving cell of the aggressor UE, or both.

13. The method of claim 10, wherein transmitting the indication of the reference cell comprises:
indicating, to the first UE, an identifier of a reference serving cell, wherein the reference serving cell is different from a serving cell of the aggressor UE.

14. An apparatus for wireless communications at a first user equipment (UE), comprising:
a processor,
memory coupled with the processor; and
instructions stored in the memory and executable by the processor to cause the apparatus to:
receive a cross-link interference measurement configuration which provides a cross-link interference measurement resource for the UE for measurement of cross-link interference from an aggressor UE;
select, based at least in part on a selection priority, a reference cell for estimation of a cross-link interference measurement resource timing;
determine a reference cell timing based on a reference signal of the reference cell;
estimate the cross-link interference measurement resource timing based at least in part on the reference cell timing; and
measure cross-link interference from the aggressor UE in accordance with the cross-link interference measurement resource timing.

15. The apparatus of claim 14, wherein the instructions to select the reference cell are executable by the processor to cause the apparatus to:
receive, with the cross-link interference measurement configuration, an indication that the reference cell is a serving cell of the aggressor UE; and
select the serving cell of the aggressor UE as the reference cell based at least in part on the selection priority.

16. The apparatus of claim 15, wherein the indication comprises a synchronization signal block index corresponding to the serving cell of the aggressor UE, a channel state information reference signal index corresponding to the serving cell of the aggressor UE, or both.

17. The apparatus of claim 16, wherein the instructions to determine the reference cell timing are executable by the processor to cause the apparatus to:
use the synchronization signal block index or the channel state information reference signal index as the reference signal from which the reference cell timing is determined.

18. The apparatus of claim 14, wherein the instructions are further executable by the processor to cause the apparatus to:
identify a frequency offset of the cross-link interference measurement resource, based at least in part on measurements of the reference signal.

19. The apparatus of claim 18, wherein the instructions are further executable by the processor to cause the apparatus to:
apply a frequency correction corresponding to the identified frequency offset in the cross-link interference measurement resource.

20. The apparatus of claim 14, wherein the instructions to select the reference cell are executable by the processor to cause the apparatus to:
identify a reference serving cell configured for estimation of the cross-link interference measurement resource timing; and
select the reference serving cell as the reference cell based at least in part on the selection priority, wherein the selection priority is that the UE selects the reference serving cell when the cross-link interference measurement configuration does not identify the reference cell as a serving cell of the aggressor UE.

21. The apparatus of claim 20, wherein the instructions to determine the reference cell timing are executable by the processor to cause the apparatus to:
use a synchronization signal block or a channel state information reference signal of the reference serving cell to determine the reference cell timing.

22. The apparatus of claim 14, wherein the instructions to select the reference cell are executable by the processor to cause the apparatus to:
select a serving cell of the UE as the reference cell based at least in part on the selection priority, wherein the selection priority is that the UE selects the serving cell of the UE when the cross-link interference measurement configuration does not identify the reference cell as a serving cell of the aggressor UE, and when no reference serving cell has been configured.

23. An apparatus for wireless communications at a base station, comprising:
a processor,
memory coupled with the processor; and
instructions stored in the memory and executable by the processor to cause the apparatus to:
transmit, to a first user equipment (UE), a cross-link interference measurement configuration which provides a cross-link interference measurement resource for measurement by the first UE of cross-link interference from an aggressor UE;
transmit, to the first UE, an indication of a reference cell to be used by the first UE for estimation of a cross-link interference measurement resource timing; and
receive a cross-link interference report from the first UE which includes one or more cross-link interference measurements made by the first UE on the cross-link interference measurement resource and in accordance with the cross-link interference measurement resource timing.

24. The apparatus of claim 23, wherein the instructions to transmit the indication of the reference cell are executable by the processor to cause the apparatus to:
indicate, with the cross-link interference measurement configuration, that the reference cell is a serving cell of the aggressor UE.

25. The apparatus of claim 24, wherein the indication comprises a synchronization signal block index corresponding to the serving cell of the aggressor UE, a channel state information reference signal index corresponding to the serving cell of the aggressor UE, or both.

26. The apparatus of claim 23, wherein the instructions to transmit the indication of the reference cell are executable by the processor to cause the apparatus to:
indicate, to the first UE, an identifier of a reference serving cell, wherein the reference serving cell is different from a serving cell of the aggressor UE.

27. An apparatus for wireless communications at a first user equipment (UE), comprising:
means for receiving a cross-link interference measurement configuration which provides a cross-link interference measurement resource for the UE for measurement of cross-link interference from an aggressor UE;
means for selecting, based at least in part on a selection priority, a reference cell for estimation of a cross-link interference measurement resource timing;
means for determining a reference cell timing based on a reference signal of the reference cell;
means for estimating the cross-link interference measurement resource timing based at least in part on the reference cell timing; and
means for measuring cross-link interference from the aggressor UE in accordance with the cross-link interference measurement resource timing.

28. An apparatus for wireless communications at a base station, comprising:
means for transmitting, to a first user equipment (UE), a cross-link interference measurement configuration which provides a cross-link interference measurement resource for measurement by the first UE of cross-link interference from an aggressor UE;
means for transmitting, to the first UE, an indication of a reference cell to be used by the first UE for estimation of a cross-link interference measurement resource timing; and
means for receiving a cross-link interference report from the first UE which includes one or more cross-link interference measurements made by the first UE on the cross-link interference measurement resource and in accordance with the cross-link interference measurement resource timing.

29. A non-transitory computer-readable medium storing code for wireless communications at a first user equipment (UE), the code comprising instructions executable by a processor to:
receive a cross-link interference measurement configuration which provides a cross-link interference measurement resource for the UE for measurement of cross-link interference from an aggressor UE;
select, based at least in part on a selection priority, a reference cell for estimation of a cross-link interference measurement resource timing;
determine a reference cell timing based on a reference signal of the reference cell;
estimate the cross-link interference measurement resource timing based at least in part on the reference cell timing; and
measure cross-link interference from the aggressor UE in accordance with the cross-link interference measurement resource timing.

30. A non-transitory computer-readable medium storing code for wireless communications at a base station, the code comprising instructions executable by a processor to:
transmit, to a first user equipment (UE), a cross-link interference measurement configuration which provides a cross-link interference measurement resource for measurement by the first UE of cross-link interference from an aggressor UE;
transmit, to the first UE, an indication of a reference cell to be used by the first UE for estimation of a cross-link interference measurement resource timing; and
receive a cross-link interference report from the first UE which includes one or more cross-link interference measurements made by the first UE on the cross-link interference measurement resource and in accordance with the cross-link interference measurement resource timing.
